(19) United States
(12) Patent Application Publication
(10) Pub. No.: US 2010/0211360 A1
(43) Pub. Date: Aug. 19, 2010

(54) METHOD FOR CALCULATING THE GEOMETRY OF A LAST FOR CUSTOMISED FOOTWEAR

(75) Inventors: Alessandro Ratti, Como (IT); Sergio Dulio, Vigevano (Pavia) (IT)

Correspondence Address: YOUNG & THOMPSON, 209 Madison Street, Suite 500, Alexandria, VA, 22314, US

(73) Assignee: MAGARI S.R.L., Milano (IT)

(21) Appl. No.: 12/678,770

(22) PCT Filed: Sep. 15, 2008
(86) PCT No.: PCT/EP08/07634

§ 371 Date: Mar. 18, 2010

(30) Foreign Application Priority Data
Sep. 18, 2007 (IT) MI2007A001803

(51) Int. Cl. G06F 17/50

(52) U.S. Cl. 703/1; 703/2

(57) ABSTRACT

A method for calculating the geometry of a last for customised footwear includes the following steps: collection in a data base of 3D models of lasts, creation of a grid of lasts having different measurements in terms of length and of fitting, acquisition of a 3D model of a foot, identification of a sub-set of at least two lasts having measurement parameters close to those of the foot, deformation of the 3D model of the foot to follow the course of the 3D last model, identification of some areas of interest of the 3D model of the foot, deformation of the 3D model of each of the lasts selected in the areas of interest so as to compensate for differences between the 3D model of the last and the 3D model of the foot and selection, on the basis of the residual errors, of the final last to be reproduced.

The present invention refers to a method for calculating the geometry of a last for customised footwear.

With the use of modern technologies, the industrial manufacture of customised footwear, produced for individual clients, involves some typical steps which can be summarised as follows.

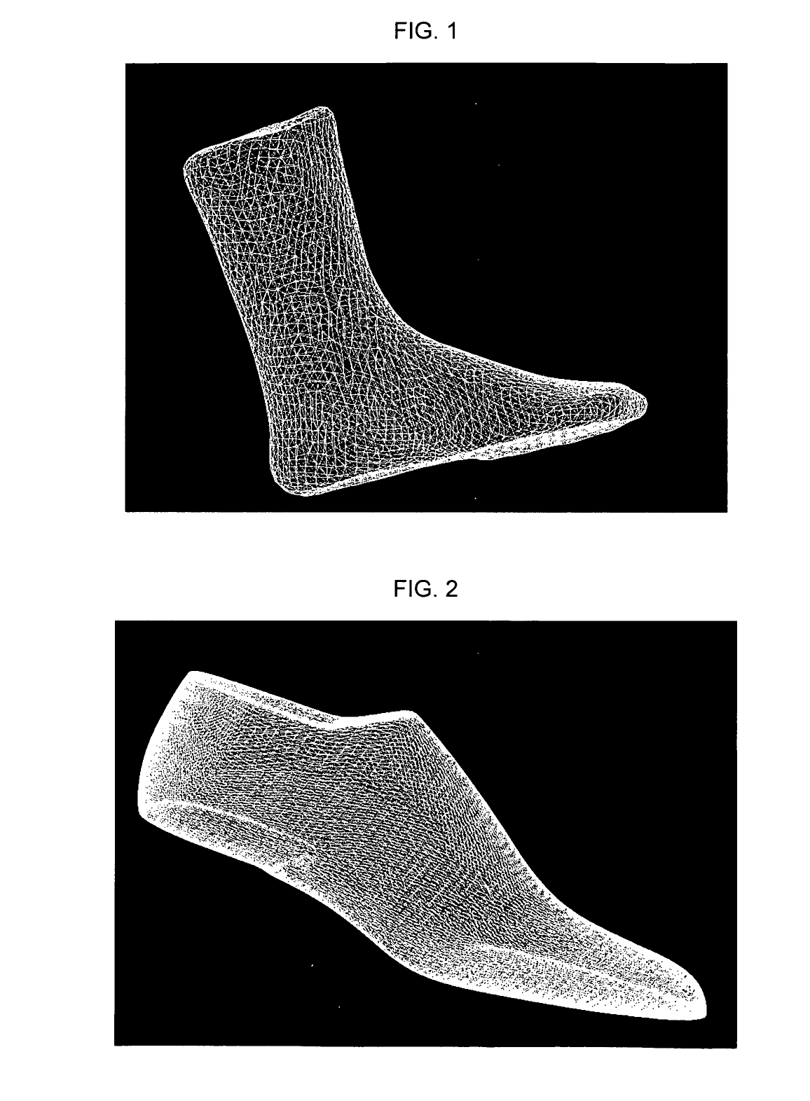

The consumer's feet (each one individually) are scanned (“digitalised”) by means of special devices called scanners, so as to acquire the digital data representative of the foot. These devices are able to detect a close network of geometrical points situated on the surface of the foot and to reconstruct a three-dimensional mathematical model of said foot from such points, as shown in FIG. 1.

Measurements of length, of width and of fitting, varying in number and in type according to the specific requirements and to the experience of each particular company, are automatically obtained on this mathematical model.

The models of footwear put on sale are manufactured by means of specific plastic devices known as lasts. The lasts too are digitalised in advance so as to reconstruct a three-dimensional mathematical model of the last as shown in FIG. 2; the digital data of the lasts are stored in a specific data base, for the whole range of lengths and of widths (fittings) provided. Measurements of the same type and of the same kind as those carried out on the foot are made on each of said lasts.

The measurements of the feet and the corresponding measurements of the lasts are compared so as to identify, among all the types of lasts contained in the data base, that which has a set of measurements that comes closest to those of the customer's foot. This procedure is called “matching” between the foot and the last and allows the best last to be chosen among those available in the data base.

Once the optimal last has been identified (different for left and right foot or paired for the two feet), it is used to manufacture the customised footwear. The matching procedure is carried out with software applications which therefore represent the central element in this process. The end quality of the footwear produced, and ultimately the customer's satisfaction, depends upon the soundness of the choice made by the software.

Some methods of the prior art able to carry out the operation of comparing and choosing a last are known, which can be summed up in the following three types:

Completely automatic applications, which choose the best last among those available in the data base, with no contribution by the operator, but the result of which is checked by trying on the shoe of the suggested size in a shop (test checking).

Semi-automatic applications, in which the result of the comparison and of the choice is visualized to an operator, who has the task of upholding or of correcting the choice at his discretion and according to his experience.

Completely manual applications (interactive), in which the operator carries out a visual comparison (by using the graphic commands made available by the software) between the measurements taken on the mathematical model of the foot and the corresponding measurements of a set of lasts, until the ideal one is identified.

All these methods perform a comparison and a choice among existing lasts and not an exact calculation of the specific geometry most suitable to enclose the customer's foot. Object of the present invention is to overcome the drawbacks of the prior art by providing a method for calculating the geometry of a last for customised footwear that is precise, practical, efficient and completely automatic.

This object is achieved in accordance with the invention with the characteristics listed in appended independent claim 1.

Advantageous embodiments of the invention are apparent from the dependent claims.

The method for calculating the geometry of a last for customised footwear according to the invention comprises the following steps:

a) collection in a database of 3D models of lasts,

b) creation of a grid of lasts, according to the measurement parameters of said lasts, taken from said 3D models,

c) acquisition of digital data of a foot so as to create a 3D model of said foot, from which the measurement parameters of said foot are obtained,

d) identification in said grid of lasts of a sub-set of at least one last having measurement parameters close to those of the foot,

e) selection of a starting 3D model of a last from said sub-set of identified lasts,

f) deformation of said 3D model of the foot in order to adapt it to the selected 3D model of last to take into account the height of the heel,

g) identification of some areas of interest in the 3D foot model,

h) controlled deformation of the 3D model of the selected last in said areas of interest, so as to compensate for differences (errors) between the 3D model of the last and the 3D model of the foot,

i) repetition of the steps from e) to h) for all the lasts of the identified sub-set of lasts,

l) choice of the final last elaborated according to the minimum amount of errors obtained between the 3D model of the foot and the elaborated 3D model of the last,

m) repetition of the steps from c) to l) for the other foot.

This method for calculating the geometry of a last for customised shoes sets out to calculate the three-dimensional geometry of an individual last that faithfully reproduces the characteristics of said foot, without impacting significantly on the aesthetic appearance of the shoe.

The correct fitting of a shoe depends upon the correct matching of some parts of the foot with said shoe. In this respect, there are parts of the shoe that are not relevant to the fitting and others that are fundamental. The method according to the invention is concerned with finding not only the best size for the foot but also with making small corrections to the last to improve the fitting of the shoe obtained with said last.

The corrections to the last are made in some areas identified as “areas of interest”. The method according to the invention nevertheless affords the possibility of modifying, by increasing or by decreasing, the number of areas of interest in which it is possible to make an adjustment to the last. Said adjustments are of a local type and their influence is limited to a certain area of the last. They are disturbances of the basic last, thus small variations necessary to better adapt the last to the foot without modifying the aesthetic aspect.

It is assumed that the last or lasts (depending on how many types of different lasts will be used to make the collection of models on sale) are available in a digital format. The lasts can, for example, be described as a cloud of dots or as a triangulated surface. The specific descriptions of the lasts are used in the algorithm according to the needs of the individual steps. In any case, the lasts are developed according to the traditional parameters of length and of fitting according to the standard procedure of the last and/or footwear manufacturer.

Further characteristics of the invention will be made clearer by the detailed description that follows, referring to a purely exemplifying and therefore non limiting embodiment thereof, wherein:

FIG. 1 is a three-dimensional view showing a 3D mathematical model of a foot;

FIG. 2 is a three-dimensional view showing a 3D mathematical model of a last;

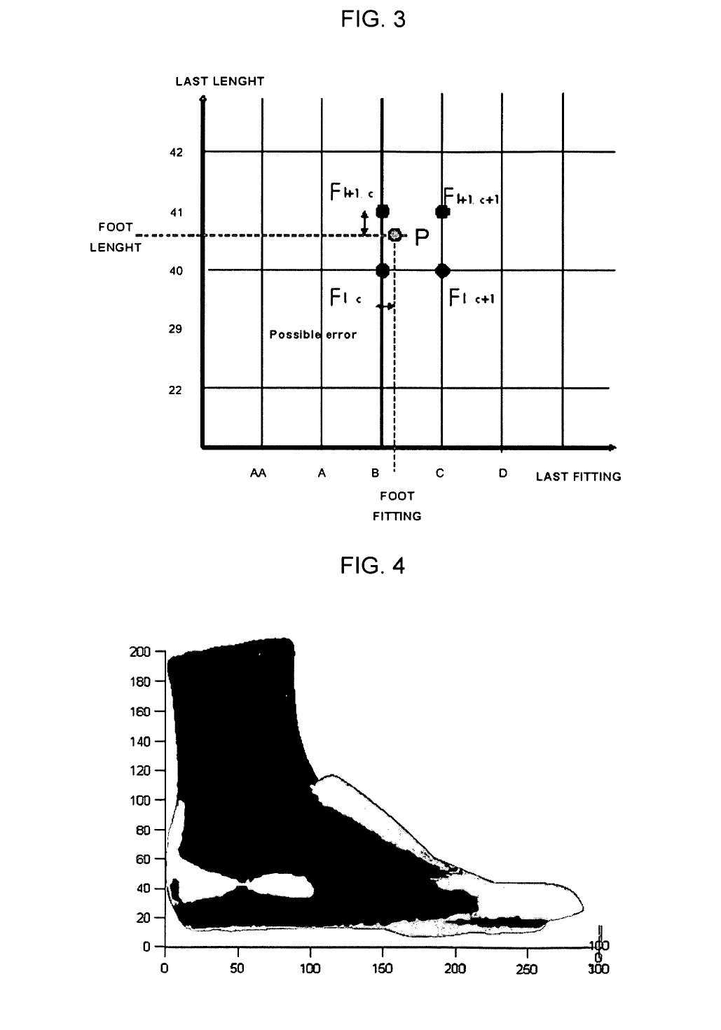

FIG. 3 is a Cartesian diagram showing a grid of lasts chosen according to measurement parameters such as the fitting and the length of the foot;

FIG. 4 is a 3D mathematical model showing the alignment of the 3D model of a foot with the 3D model of a last;

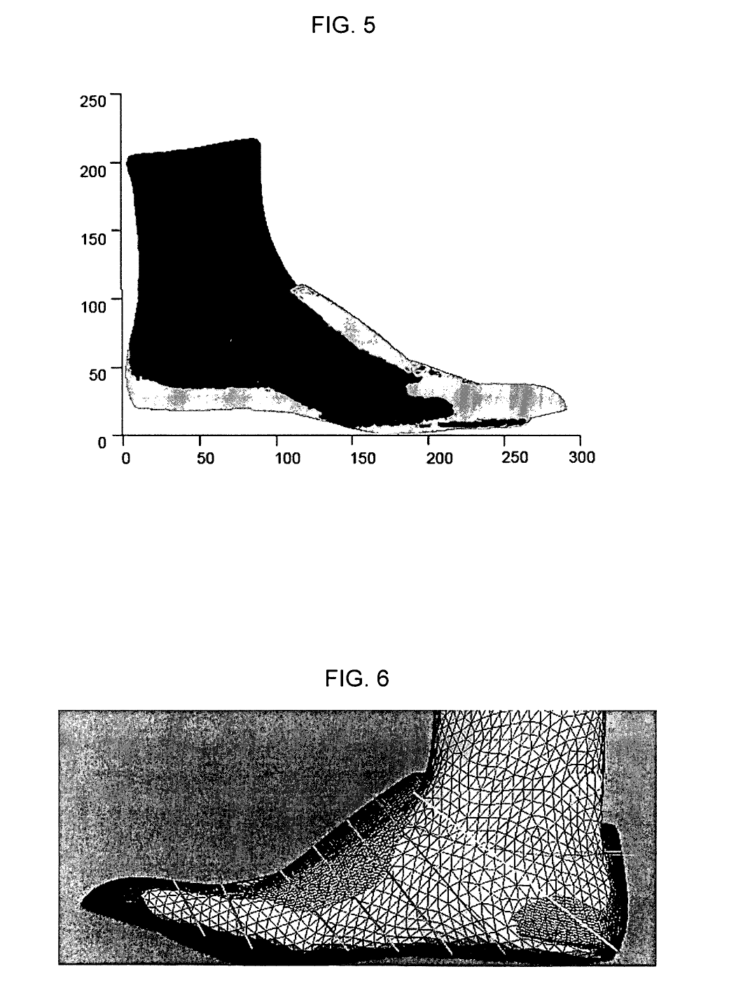

FIG. 5 is a 3D mathematical model showing the deformation of the 3D model of the foot to follow the course of the 3D model of the last, so as to take into account the height of the heel;

FIG. 6 is a 3D mathematical model of a foot and of a last showing some pre-established areas of interest of the 3D model of the foot;

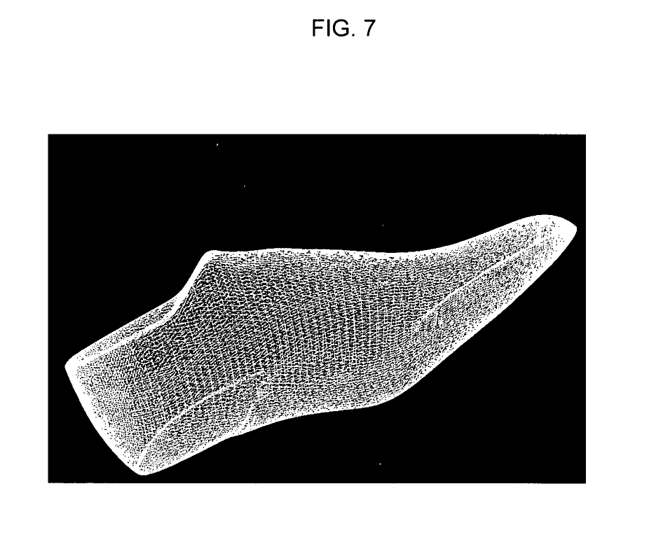

FIG. 7 is a 3D mathematical model of an optimal last obtained by the method according to the invention.

The method for calculating the geometry of a last for footwear that adapts optimally to the user's foot is described with the aid of the figures.

A data base of 3D models of lasts, like the 3D model in FIG. 2, is available. All the models of lasts in the data base are grouped in a grid of lasts that can be represented in a Cartesian diagram, as shown FIG. 3.

Each point on the grid represents a last which is chosen, for example, on the basis of the length (shown on the y-axis) and of the fitting (shown on the x-axis). Clearly, other measurement parameters may be used to create the grid of FIG. 3.

The user's foot is scanned with a 3D scanner so as to generate a three-dimensional representation (model) of the foot (like that shown in FIG. 1) from which the true measurements of the length and of the fitting of the foot, defining a point P on the grid of FIG. 3, are obtained. In this manner, the area of the measurement grid into which the foot in question falls is identified.

In the example in FIG. 3, the point P falls within a square of the grid that identifies, indicatively, a sub-set of the four closest lasts (designated F_{l,c}, F_{l+l,c}, F_{l+l,c+l}, F_{l,c+l}), whose length and fitting measurements approximate, by defect or by excess, those of the foot. Preferably, all four of these lasts or only two of them, or even only one, can be used in the next stages. In any case, in the method according to the invention a sub-set of at least one last that comes close to the measurements of the foot must be identified, which must be used in the next steps. Another method of selecting the lasts to be used in the subsequent calculations consists in calculating the quadratic sum of the differences of corresponding flat sections of the foot and of the lasts. The lasts for which the minimum of the sum calculated is obtained are considered valid for the next steps.

A starting last is chosen (for example the last F_{l,c}), of which there is a three-dimensional model like that shown in FIG. 2. As shown in FIG. 4, the three-dimensional model of the foot obtained with the scanner is aligned with that of the last F_{l,c}.

Since the foot is acquired on a flat surface, whereas the last base is curved because of the height of the heel, as shown in FIG. 5, the model of the foot is deformed (positioned) to follow the course of the model of the last. This allows the foot to be positioned as if it had been acquired with the correct heel height.

As shown in FIG. 6, in the three-dimensional model of the foot, some characteristic areas of interest are automatically identified. These areas of interest can be distances between points, sets of points or even flat or not flat surfaces. By way of example, six areas of interest have been identified:

1) the innermost and outermost points of the sole of the foot;

2) the height of the foot at the instep;

3) the position of the heel;

4) the sections obtained by cutting the foot with a variable number of parallel or even not parallel planes;

5) the hollow inner part of the foot corresponding to the area of the last called the “arch”, and

6) the portion of the last corresponding to the sole.

A weight can be given to each of these areas of interest, so that the last resulting from the calculation depends, to a greater or lesser extent, on said area of interest according to the importance given to it by the weight.

A controlled deformation of the surface of the 3D model of the last is carried out at these characteristic points and sections of the areas of interest. This deformation is carried out by moving the points of the surface of the model of the last according to a Gaussian function having such a peak as to compensate for any differences at that point between the model of the foot and the model of the last, and a variance such as to smooth the deformation of the model of the last so that the last obtained from said model can be used to manufacture a footwear that does not lose its aesthetic characteristics. Where the tarsal width is corrected, a small correction is also made to the length by the model so as to maintain the aesthetic appearance of the shoe as close as possible to the starting one.

In the event of the areas of interest being flat sections of the model of the foot, to compensate for the differences in length between the model of the last and the model of the foot calculated on these flat sections, the deformation of the model of the last is corrected in the direction of the greatest difference calculated between the model of the last and the model of the foot along a straight line that passes through the centre of gravity of the section. The deformation applied to the model of the last always follows a Gaussian law having as its peak value a value able to cancel out the error on the length and a variance able not to modify the aesthetic aspect of the last.

The deformations to be applied to the last can be partially modified according to a parameter that indicates whether the foot appears “fat” (which normally corresponds to a foot with a larger fitting than normal) or “thin” (which corresponds to a foot with a smaller fitting than normal): in fact the shoe for a “fat” foot must be “narrower” with respect to the optimal last and vice versa for a thin foot.

To limit possible statistical errors, the model of the foot used for the calculation is preferably obtained by averaging a plurality of measurements of the same foot, which is advantageously sampled during weight bearing (subject standing) and not weight bearing (subject sitting or in another position), where the feet do not support the weight of the body.

The procedure described is also repeated for all the other lasts (F_{l+l,c}, F_{l+l,c+l}, F_{l,c+l}), of the sub-set of lasts defined in the grid of FIG. 3. After these automatic calculations, the final, optimal last is elaborated, again automatically, on the basis of metrics that depend upon the errors of the last in the single areas of interest in which the elaborations have been carried out.

Lastly, as shown in FIG. 7, the 3D model of the optimal last that best suits the foot in question is obtained.

The procedure carried out for the right foot, for example, is repeated for the left foot, so as to generate a pair of lasts that will be sent to the production for the manufacture of the customised footwear.

Unlike what is done by the methods of the prior art, the best last for the foot (left and right individually) of each consumer is obtained with a calculation and not simply chosen in a library of existing lasts. The last is actually calculated to measure for each consumer.

Furthermore, the procedure for the elaboration of the last is carried out automatically, without any intervention or contribution of skill by the operator and without carrying out tests with sample footwear in the shop. The applications currently available require the supervision or direct contribution of an expert operator.

1-12. (canceled)

13. A method for calculating the geometry of a last for customised footwear comprising the following steps:
a) collection in a database of 3D models of lasts,
b) creation of a grid of lasts, according to the measurement parameters of said lasts taken from said 3D models,
c) acquisition of digital data of a foot so as to create a 3D model of said foot, from which the measurement parameters of said foot are obtained,
d) identification in said grid of lasts of a sub-set of at least one last having measurement parameters close to those of the foot,
e) selection of a starting 3D model of a last from said sub-set of identified lasts,
f) deformation of said 3D model of the foot in order to adapt it to the course of the selected 3D model of last and to take into account the height of the heel,
g) identification of some areas of interest in the 3D foot model,
h) controlled deformation of the 3D model of the selected last in said areas of interest, so as to compensate for differences (errors) between the 3D model of the last and the 3D model of the foot,
i) repetition of the steps from e) to h) for all the lasts of the identified sub-set of lasts,
l) elaboration of the final last according to the minimum amount of errors obtained between the 3D model of the foot and the starting 3D model of the last,
m) repetition of the steps from c) to l) for the other foot.
wherein
said controlled deformation of the last in said areas of interest is done in a fully automatic and non assisted way by moving the points of the surface of the 3D model of the last according to a Gaussian function having such a peak to compensate for any difference at that point between the model of the foot and the model of the last and such a variance as to carry out a rounding of the model of the last so as not to lose the aesthetic features of the footwear obtained with said last.

14. A method according to claim 13, wherein the measurement parameters of the lasts and of the foot include the length of the foot and the fitting.

15. A method according to claim 13, wherein said areas of interest of the 3D model of the foot include one or more of the following areas:
the innermost and outermost points of the sole of the foot;
the height of the foot at the instep;
the position of the heel;
the sections obtained by cutting the foot with a variable number of parallel or even not parallel planes;
the hollow inner part of the foot corresponding to the area of the last called the “arch”, and
the portion of the last corresponding to the sole.

16. A method according to claim 13, wherein a weight is given to each of said areas of interest, so that the last resulting from the calculation depends, to a greater or lesser extent, on said area of interest according to the importance attributed to it by the weight assigned.

17. A method according to claim 13, wherein said areas of interest are flat sections of the model of the foot and the deformation of the model of the last is corrected in the direction of the greatest distance calculated between the model of the last and the model of the foot along a straight line that passes through the centre of gravity of the flat section.

18. A method according to claim 13, wherein the model of the foot used for the calculation is obtained by averaging a plurality of measurements of the same foot to limit possible statistical errors.

19. A method according to claim 13, wherein the foot is sampled during weight bearing (subject standing) and not weight bearing (subject sitting or in another position) where the feet do not support the weight of the body.

20. A method according to claim 13, wherein the corrections applied to the model depend upon an empirical evaluation of the characteristic of the foot of being “fat” (on average with a larger fitting than the average one) or “thin” (on average with a smaller fitting than the average one).

21. A method according to claim 13, wherein the selection of the models to be used in the calculations is done by calculating the sum of the squares of the differences of corresponding sections of the foot and of the model and by determining the model that occupies the minimum value of the difference.

22. A method according to claim 13, wherein the selection of the models to be used in the calculations is done by calculating metrics that allow the foot-model difference to be distinguished.
